(19) United States
(12) Patent Application Publication
(10) Pub. No.: US 2018/0170774 A1
(43) Pub. Date: Jun. 21, 2018

(54) DEVICE AND METHOD FOR GENERATING OXIDANTS IN SITU

(71) Applicants: Zijun XIA, Shanghai (CN); Caroline Chihyu SUI, Trevose, PA (US); Yida XU, Shanghai (CN); Xing ZHANG, Shanghai (CN); Qunjian HUANG, Shanghai (CN); Stephen Robert VASCONCELLOS, Trevose, PA (US); Michael Brian SALERNO, Trevose, PA (US); General Electric Company, Schenectady, NY (US)

(72) Inventors: Zijun Xia, Shanghai (CN); Caroline Chihyu Sui, Trevose, PA (US); Yida Xu, Shanghai (CN); Xing Zhang, Shanghai (CN); Qunjian Huang, Shanghai (CN); Stephen Robert Vasconcellos, Trevose, PA (US); Michael Brian Salerno, Trevose, PA (US)

(21) Appl. No.: 15/736,017

(22) PCT Filed: Dec. 31, 2014
(86) PCT No.: PCT/CN2014/095776

§ 371 Date: Dec. 13, 2017

(51) Int. Cl. C02F 1/467; C02F 1/461; C02F 1/44; B01D 61/04; B01D 61/02

(52) U.S. Cl. CPC C02F 1/4674; C02F 1/4672; C02F 1/46109; C02F 1/441; C02F 2101/345; B01D 61/025; C02F 2001/46138; C02F 2001/46166; B01D 61/04

(57) ABSTRACT

A method of reducing the organic compounds in an aqueous stream by generating an oxidant in-situ using at least one electrolytic cell. The method may comprise contacting at least a portion of the aqueous stream with the electrolytic cell. The electrolytic cell may have at least two electrodes, wherein at least one electrode is a metal electrode and, a power source for powering the at least two electrodes. A water treatment system for generating an oxidant in-situ comprising at least one electrolytic cell. The electrolytic cell may have at least two electrodes, wherein at least one electrode is a metal electrode, and a power source for powering the at least two electrodes. A method of improving the rejection rate of a reverse osmosis membrane using an oxidant generated in-situ. The method may comprise contacting at least a portion of the aqueous stream with the electrolytic cell thereby creating an oxidized aqueous stream. At least a portion of the oxidized aqueous stream may be fed through a reverse osmosis membrane. The electrolytic cell may comprise at least two electrodes, wherein at least one electrode is a metal electrode, and a power source for powering the at least two electrodes.

### FIELD OF THE INVENTION

This invention relates generally to equipment for use in generating oxidants in-situ via electrolysis to reduce organic compounds in aqueous streams. The organic compounds may include bacteria, aromatic compounds, N-containing organics or organic acids.

### BACKGROUND OF THE INVENTION

Water quality is often indicated by the amount of organic compounds, or the total organic carbon (TOC) present in the sample. TOC is a well-established water quality parameter that quantifies the overall concentration of organic substances, all of which are typically regarded as contaminants. In most aqueous samples, such as drinking water, raw water, wastewater, industrial process streams, and the like, the total carbon (TC) is the sum of the amount of total organic carbon (TOC) and the amount of inorganic carbon (IC) present in the sample.

Electrolytic cells are electrochemical cells in which energies from applied voltages are used to drive otherwise nonspontaneous reactions. These cells are sometimes used in water treatment systems and methods, for example, to produce oxidants for reducing levels of organic compounds, such as microorganisms or aromatic hydrocarbons in aqueous streams.

Generally, organic pollutants dissolved in the water can be destroyed electrochemically by direct anodic oxidation at the electrode surface or indirectly through oxidation processes mediated by electrogenerated oxidants. The compound's oxidation potential and the choice of electrode material both influence whether oxidation is by direct or indirect means.

### SUMMARY OF THE INVENTION

Accordingly, systems and methods are disclosed for using electrolytic cells to reduce the amount of organic compounds in aqueous streams. In one embodiment, a method of reducing organic compounds in an aqueous stream is disclosed. The organic compounds are reduced by generating oxidants in-situ using at least one electrolytic cell. At least a portion of the aqueous stream may be contacted with the electrolytic cell. The electrolytic cell may comprise at least two electrodes, wherein at least one electrode is an anode and at least one electrode is a cathode, and wherein at least one electrode is a metal electrode. The electrolytic cell may have a power source for powering the at least two electrodes.

Suitable metals for the metal electrode may include, but are not limited to, titanium, nickel, aluminum, molybdenum, niobium, tin, tungsten, zinc, and combinations thereof. In one embodiment, the metal electrode may be a titanium plate electrode. In another embodiment, the metal electrode may comprise a metal coating. Suitable metal coatings include, but are not limited to ruthenium, iridium, antimony, tin, palladium, platinum, manganese dioxide and combinations thereof. Exemplary metal coatings include, but are not limited to, antimony-doped tin dioxide and ruthenium-iridium oxide. Accordingly, in one embodiment, at least one electrode may be a titanium plate electrode coated with a metal comprising antimony-doped tin oxide. In yet another embodiment, at least one electrode may be a titanium plate electrode coated with a metal comprising ruthenium-iridium oxide.

In another embodiment of the invention, the cathode may have a polymer coating. The coating may be on a metal cathode or a gas diffusion cathode. In yet another embodiment, the cathode may be a titanium plate electrode coated with a metal comprising ruthenium-iridium oxide and a polymer coating. The polymer coating may comprise a polymer comprising structural units of formula I

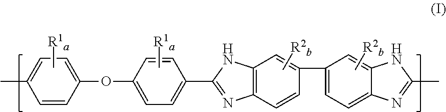

wherein R¹ is independently at each occurrence a C₁-C₆ alkyl radical or —SO₃M wherein M is a hydrogen or an alkali metal, R² is independently at each occurrence a C₁-C₆ alkyl radical, a is independently at each occurrence an integer ranging from 0 to 4, and b is independently at each occurrence an integer ranging from 0 to 3.

In another embodiment, the electrolytic cell may comprise at least two metal electrodes. The metal electrodes may be the same or different. For example, in one embodiment, one electrode may be a titanium plate electrode coated with a metal comprising antimony-doped tin oxide and one electrode may be a titanium plate electrode coated with a metal comprising ruthenium-iridium oxide. Alternatively, both electrodes may be made of the same material. In yet another embodiment, at least one metal electrode may be coated with the polymer coating described above.

In yet another embodiment of the invention, the electrolytic cell may comprise at least one gas diffusion electrode. A gas comprising oxygen may be fed to the gas diffusion electrode. Suitable gases include, air, oxygen, and combinations thereof. The electrolyte used may be selected based on the desired reaction. Suitable electrolytes include sulfuric acid, sodium sulfate, potassium sulfate, phosphoric acid, sodium phosphate, potassium phosphate, sodium hydroxide, sodium chloride, and combinations thereof. The electrolyte may be present in a solution in a concentration ranging from about 50 mg/l to about a saturated solution. In yet another embodiment, the gas diffusion electrode may comprise the polymer coating described above.

The oxidant produced using the methods and cells described above may be ozone, hydrogen peroxide, peroxone, chlorine dioxide, and combinations thereof. The oxidants may be used to reduce organic compounds in an aqueous stream. In one embodiment the organic compounds may include aromatic organic compounds, bacteria, N-containing organics or organic acids, or mixtures thereof. In another embodiment, the organic compounds may include an aromatic organic compound. Exemplary aromatic organic compounds include monocyclic or polycyclic aromatic hydrocarbons. Specific examples of aromatic hydrocarbons include, but are not limited to, aniline, benzene, toluene, nitrobenzene, xylene, phenol, polyphenol, pyrene, benzopyrene, tetracene, and flourene. In yet another embodiment, the organic compounds may include N-containing organics or organic acids such as formic acid, oxalic acid, acetic acid, succinic acid, salicylic acid and related ions.

The organic compounds may also include microbiological matter such as bacteria. Non-limiting examples of bacteria include Pseudomonas aeruginosa, Pseudomonas fluorescens, Pseudomonas putida, Desulfovibrio desulfuricans, Klebsiella, Comamonas terrigena, Nitrosomonas europaea, Nitrobacter vulgaris, Sphaerotilus natans, Gallionella species, Mycobacterium terrae, Bacillus subtilis, Flavobacterium breve, Salmonella enterica, enterica serovar Typhimurium, Bacillus atrophaeus spore, Bacillus megaterium, Enterobacter aerogenes, Actinobacillus actinomycetemcomitans, Candida albicans and Ecsherichia coli.

In another embodiment, a water treatment system for generating oxidants in-situ is disclosed. The oxidants produced using the water treatment system may be ozone, hydrogen peroxide, peroxone, chlorine dioxide, and combinations thereof. The water treatment system may be used to reduce organic compounds in an aqueous stream. The organic compounds may be an aromatic organic compound or a bacteria, or mixtures thereof, as described above.

The water treatment system may comprise at least one electrolytic cell, having at least two electrodes, and a power source for powering the electrodes. At least one electrode may be a metal electrode as described above.

In another embodiment, the system's electrolytic cell may comprises at least two metal electrodes. The metal electrodes may be the same or different. For example, in one embodiment, one electrode may be a titanium plate electrode coated with a metal comprising antimony-doped tin oxide and one electrode may be a titanium plate electrode coated with a metal comprising ruthenium-iridium oxide. Alternatively, both electrodes may be made of the same material. In yet another embodiment, at least one metal electrode may be coated with the polymer coating described above.

In yet another embodiment, the system's electrolytic cell may comprises at least one gas diffusion electrode. A gas comprising oxygen may be fed to the gas diffusion electrode Suitable gases include, air, oxygen, and combinations thereof. In yet another embodiment, the gas diffusion electrode may comprise the polymer coating described above.

The electrolyte used may selected based on the desired reaction. Suitable electrolytes include sulfuric acid, sodium sulfate, potassium sulfate, phosphoric acid, sodium phosphate, potassium phosphate, sodium hydroxide, sodium chloride, and combinations thereof.

In yet another embodiment of the invention, a method of improving the rejection rate of a reverse osmosis membrane using an oxidant generated in-situ is disclosed. The method may comprise contacting at least a portion of the aqueous stream with said electrolytic cell thereby creating an oxidized aqueous stream. At least a portion of the oxidized aqueous stream may be fed through a reverse osmosis membrane. The electrolytic cell may comprise at least two electrodes, wherein at least one electrode is a metal electrode, and a power source for powering the at least two electrodes. In another method embodiment, the metal electrode may any metal electrode as described above. In yet another embodiment, the electrolytic cell may comprise at least two metal electrodes. In another embodiment, both the anode and cathode may be a titanium plate electrode coated with ruthenium-iridium Ru/Ir oxide.

In yet another embodiment, the cathode may have a polymer coating as described above. In yet another embodiment, the cathode may have polymer coating comprising OPBI (poly[2,20-(p-oxydiphenylene)-5,50-bibenzimidazole]).

In another embodiment, the oxidant produced may be chlorine dioxide. In yet another embodiment, the method of improving the rejection rate of a reverse osmosis membrane may also be used to reduce organic compounds in an aqueous stream. The organic compounds may include aromatic organic compounds, bacteria, N-containing organics or organic acids, or mixtures thereof, as described above.

### BRIEF DESCRIPTION OF THE DRAWINGS

The above and other aspects, features, and advantages of the present disclosure will become more apparent in light of the following detailed description when taken in conjunction with the accompanying drawings.

FIG. 1 shows the ozone concentration with respect to time and the UV absorption with respect to time according to one embodiment of the invention.

FIG. 2 shows the shows the standard working curve of ozone concentration related to UV absorption according to one embodiment of the invention.

FIG. 3 shows the hydrogen peroxide generated with respect to time when feeding air to the gas diffusion electrode according to one embodiment of the invention.

FIG. 4 shows the hydrogen peroxide generated with respect to time when feeding oxygen to the gas diffusion electrode according to one embodiment of the invention.

FIG. 5 shows the chromatographs of prepared water samples after treatment according to one embodiment of the invention.

FIG. 6 shows the chromatographs of prepared water samples after treatment according to one embodiment of the invention.

FIG. 7 shows the chromatographs of prepared alkaline water samples after treatment according to one embodiment of the invention.

FIG. 8 shows the chlorine dioxide generated using an exemplary system.

FIG. 9 shows the chlorine dioxide generation efficiency of both the OPBI-coated cathode and uncoated cathode exemplary systems.

FIG. 10 shows the weight of the permeate over a 10 minute period with respect to time according to one embodiment of the invention.

FIG. 11 shows the conductivity of the permeate with respect to time according to one embodiment of the invention.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The singular forms “a,” “an” and “the” include plural referents unless the context clearly dictates otherwise.

In one embodiment, a method of reducing organic compounds an aqueous stream is disclosed. The organic contaminants or compounds are reduced by generating an oxidant in-situ using at least one electrolytic cell. At least a portion of the aqueous stream may be contacted with the electrolytic cell. The electrolytic cell may comprise at least two electrodes, wherein at least one electrode is an anode and at least one electrode is a cathode, and wherein at least one electrode is a metal electrode. The electrolytic cell may have a power source for powering the at least two electrodes.

Suitable metals for the metal electrode may include, but are not limited to, titanium, nickel, aluminum, molybdenum, niobium, tin, tungsten, zinc, and combinations thereof. In one embodiment, the metal electrode may be a titanium plate electrode. In another embodiment, the metal electrode may comprise a metal coating selected from the group consisting of ruthenium, iridium, antimony, tin, palladium, platinum,manganese dioxide and combinations thereof. Exemplary metal coatings include, but are not limited to, antimony-doped tin dioxide and ruthenium-iridium oxide. Accordingly, in one embodiment, at least one electrode may be a titanium plate electrode coated with a metal comprising antimony-doped tin oxide. In yet another embodiment, at least one electrode may be a titanium plate electrode coated with a metal comprising ruthenium-iridium oxide.

In another embodiment of the invention, the cathode may have a polymer coating. The coating may be on a metal cathode or a gas diffusion cathode. In yet another embodiment, the electrode may be a titanium plate electrode coated with a metal comprising ruthenium-iridium oxide and a polymer coating. The polymer coating may comprise a polymer comprising structural units of formula I

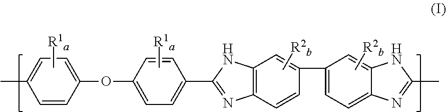

wherein R¹ is independently at each occurrence a C₁-C₆ alkyl radical or —SO₃M wherein M is a hydrogen or an alkali metal, R² is independently at each occurrence a C₁-C₆ alkyl radical, a is independently at each occurrence an integer ranging from 0 to 4, and b is independently at each occurrence an integer ranging from 0 to 3.

In some embodiments, b=0, a=0 and the polymer comprising structural units of formula I is poly[2,20-(p-oxydiphenylene)-5,50-bibenzimidazole] (OPBI) prepared, in some embodiments, by the condensation of diamine and benzoic acid derivatives in the presence of a catalyst and a solvent with heating. Examples of the catalyst include, but are not limited to, P₂O₅, polyphosphoric acids, and concentrated sulfuric acid. Examples of the solvent include, but are not limited to, methanesulfonic acid, trifluoromethanesulfonic acid, 4-(trifluoromethyl)benzenesulfonic acid, dimethyl sulfur oxide, dimethylamide acetate, dimethyl formamide. The heating temperature may be in a range of from about 50° C. to about 300° C., preferred of from about 120° C. to about 180° C.

In some embodiments, b=0, a=1, R₁ is —SO₃H, and the polymer comprising structural units of formula I is sulfonated poly[2,20-(p-oxydiphenylene)-5,50-bibenzimidazole] (SOPBI) prepared by the post-sulfonation reaction of the OPBI polymer, using concentrated and fuming sulfuric acid as the sulfonating reagent at a temperature in a range of from about 25° C. to about 200° C., and preferred in a range of from about 50° C. to about 100° C. The degree of sulfonation is not limited and may be as high as 100% by adjusting the reaction conditions.

The polymer coating may be formed through the following steps: mixing a solution of the polymer comprising structural units of formula I, e.g., in any one or more of dimethyl sulphoxide (DMSO), N-methylpyrrolidone (NMP), dimethylformamide (DMF), and dimethylacetamide (DMAc), with a solution of sodium hydroxide, e.g., in one or more of ethanol, methanol, and isopropyl alcohol, to prepare a coating solution. The coating solution or polymer coating may be applied to the electrode using a variety of methods. These methods include, but are not limited to, “painting” the solution onto the electrode, immersing the electrode in the solution, forming a membrane from the solution and hot pressing the membrane to the electrode, and electrospinning the solution to fiber-coat the electrode. In some embodiments, the electrode may then be put in a vacuum and dried. The coating solution may be filtered through a polytetrafluoroethylene (PTFE) filter and degassed under a reduced pressure before being applied to the electrode. In some embodiments, the electrode may be washed using water after drying to remove the residual solvent, if any.

In some embodiments, the electrode may be immersed in a solution of the SOPBI polymer and a suitable crosslinking agent such as Eaton's reagent (phosphorus pentoxide solution in methanesulfonic acid in the weight ratio of 1:10) at about 50˜150° C. for 10˜60 minutes to be coated with crosslinked SOPBI polymer with a better mechanical strength and a smaller swelling ratio. Alternatively, the electrode may be immersed at about 80° C. for about 60 minutes.

In another embodiment, the electrolytic cell may comprise at least two metal electrodes. The metal electrodes may be the same or different. For example, in one embodiment, one electrode may be a titanium plate electrode coated with a metal comprising antimony-doped tin oxide and one electrode may be a titanium plate electrode coated with a metal comprising ruthenium-iridium oxide. Alternatively, both electrodes may be made of the same material. In yet another embodiment, at least one metal electrode may be coated with the polymer coating described above.

In yet another embodiment of the invention, the electrolytic cell may comprise at least one gas diffusion electrode. A gas comprising oxygen may be fed to the gas diffusion electrode. Suitable gases include, air, oxygen, and combinations thereof. In yet another embodiment, the gas diffusion electrode may comprise the polymer coating described above.

The electrolyte used may selected based on the desired reaction. Suitable electrolytes include sulfuric acid, sodium sulfate, potassium sulfate, phosphoric acid, sodium phosphate, potassium phosphate, sodium hydroxide, sodium chloride, and combinations thereof. The electrolyte may be present in a solution in a concentration ranging from about 50 mg/l to about a saturated solution.

The oxidant produced using the methods and cells described above may be ozone, hydrogen peroxide, peroxone, chlorine dioxide, or combinations thereof. The oxidants may be used to reduce organic compounds in an aqueous stream. In one embodiment the organic compounds may include aromatic organic compounds, bacteria, N-containing organics or organic acids, or mixtures thereof. In another embodiment, the organic compounds may be an aromatic organic compound. Exemplary aromatic organic compounds include monocyclic or polycyclic aromatic hydrocarbons. Specific examples of aromatic hydrocarbons include, but are not limited to, aniline, benzene, toluene, nitrobenzene, xylene, phenol, polyphenol, pyrene, benzopyrene, tetracene, and flourene. In yet another embodiment, the organic compounds may include N-containing organics or organic acids such as formic acid, oxalic acid, acetic acid, succinic acid, salicylic acid and related ions.

In one embodiment, organic compounds comprising phenol may be reduced through in-situ generation of peroxone. Without limiting the invention to one theory of operation, the phenol may be reduced via the reaction below.

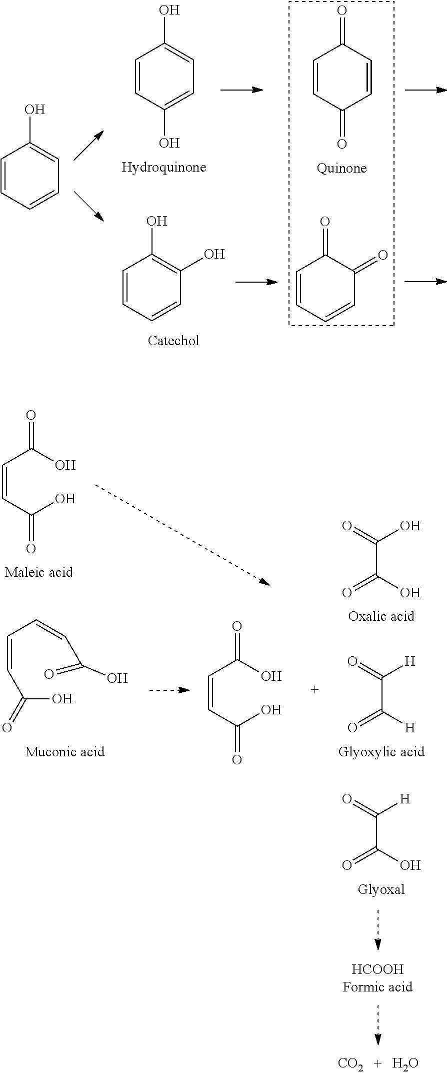

The reaction may produce intermediate by products, including catechol.

The organic compounds may also include microbiological matter such as bacteria. Non-limiting examples of bacteria include Pseudomonas aeruginosa, Pseudomonas fluorescens, Pseudomonas putida, Desulfovibrio desulfuricans, Klebsiella, Comamonas terrigena, Nitrosomonas europaea, Nitrobacter vulgaris, Sphaerotilus natans, Gallionella species, Mycobacterium terrae, Bacillus subtilis, Flavobacterium breve, Salmonella enterica, enterica serovar Typhimurium, Bacillus atrophaeus spore, Bacillus megaterium, Enterobacter aerogenes, Actinobacillus actinomycetemcomitans, Candida albicans and Ecsherichia coli.

In another embodiment, a water treatment system for generating an oxidant in-situ is disclosed. The oxidant produced using the water treatment system may be ozone, hydrogen peroxide, peroxone, chlorine dioxide, and combinations thereof. The water treatment system may be used to reduce organic compounds in an aqueous stream. The organic compounds may include aromatic organic compounds, bacteria, N-containing organics or organic acids, or mixtures thereof, as described above.

The water treatment system may comprise at least one electrolytic cell, having at least two electrodes, and a power source for powering the electrodes. At least one electrode may be a metal electrode as described above.

In another embodiment, the system's electrolytic cell may comprises at least two metal electrodes. The metal electrodes may be the same or different. For example, in one embodiment, one electrode may be a titanium plate electrode coated with a metal comprising antimony-doped tin oxide and one electrode may be a titanium plate electrode coated with a metal comprising ruthenium-iridium oxide. Alternatively, both electrodes may be made of the same material. In yet another embodiment, at least one metal electrode may be coated with the polymer coating described above.

In yet another embodiment, the system's electrolytic cell may comprises at least one gas diffusion electrode. A gas comprising oxygen may be fed to the gas diffusion electrode Suitable gases include, air, oxygen, and combinations thereof. In yet another embodiment, the gas diffusion electrode may comprise the polymer coating described above.

The electrolyte used may be selected based on the desired reaction. Suitable electrolytes include sulfuric acid, sodium sulfate, potassium sulfate, phosphoric acid, sodium phosphate, potassium phosphate, sodium hydroxide, sodium chloride, and combinations thereof. The electrolyte may be present in a solution in a concentration ranging from about 50 mg/l to about a saturated solution.

In yet another embodiment of the invention, a method of improving the rejection rate of a reverse osmosis membrane using an oxidant generated in-situ is disclosed. The method may comprise contacting at least a portion of the aqueous stream with said electrolytic cell thereby creating an oxidized aqueous stream. At least a portion of the oxidized aqueous stream may be fed through a reverse osmosis membrane. The electrolytic cell may comprise at least two electrodes, wherein at least one electrode is a metal electrode, and a power source for powering the at least two electrodes. In another method embodiment, the metal electrode may any metal electrode as described above. In yet another embodiment, the electrolytic cell may comprise at least two metal electrodes. In another embodiment, both the anode and cathode may be a titanium plate electrode coated with ruthenium-iridium Ru/Ir oxide.

In yet another embodiment, the cathode may have a polymer coating. The polymer coating may be applied to either a metal cathode or a gas diffusion electrode. The polymer coating may comprise a polymer comprising structural units of formula I

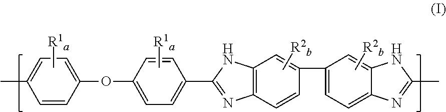

wherein R¹ is independently at each occurrence a C₁-C₆ alkyl radical or —SO₃M wherein M is a hydrogen or an alkali metal, R² is independently at each occurrence a C₁-C₆ alkyl radical, a is independently at each occurrence an integer ranging from 0 to 4, and b is independently at each occurrence an integer ranging from 0 to 3.

In some embodiments, b=0, a=0 and the polymer comprising structural units of formula I is poly[2,20-(p-oxydiphenylene)-5,50-bibenzimidazole] (OPBI) prepared, in some embodiments, by the condensation of diamine and benzoic acid derivatives in the presence of a catalyst and a solvent with heating. Examples of the catalyst include, but are not limited to, P₂O₅, polyphosphoric acids, and concentrated sulfuric acid. Examples of the solvent include, but are not limited to, methanesulfonic acid, trifluoromethanesulfonic acid, 4-(trifluoromethyl)benzenesulfonic acid, dimethyl sulfur oxide, dimethylamide acetate, dimethyl formamide. The heating temperature may be in a range of from about 50° C. to about 300° C., preferred of from about 120° C. to about 180° C.

In some embodiments, b=0, a=1, R₁ is —SO₃H, and the polymer comprising structural units of formula I is sulfonated poly[2,20-(p-oxydiphenylene)-5,50-bibenzimidazole] (SOPBI) prepared by the post-sulfonation reaction of the OPBI polymer, using concentrated and fuming sulfuric acid as the sulfonating reagent at a temperature in a range of from about 25° C. to about 200° C., and preferred in a range of from about 50° C. to about 100° C. The degree of sulfonation is not limited and may be as high as 100% by adjusting the reaction conditions. In yet another embodiment, the cathode may have polymer coating comprising OPBI (poly[2,20-(p-oxydiphenylene)-5,50-bibenzimidazole]).

In another embodiment, the oxidant produced may be chlorine dioxide. In yet another embodiment, the method of improving the rejection rate of a reverse osmosis membrane may also be used to reduce organic compounds in an aqueous stream. The organic compounds may include aromatic organic compounds, bacteria, N-containing organics or organic acids, or mixtures thereof, as described above. In yet another embodiment, the organic compounds include bacteria. Non-limiting examples of bacteria include Pseudomonas aeruginosa, Pseudomonas fluorescens, Pseudomonas putida, Desulfovibrio desulfuricans, Klebsiella, Comamonas terrigena, Nitrosomonas europaea, Nitrobacter vulgaris, Sphaerotilus natans, Gallionella species, Mycobacterium terrae, Bacillus subtilis, Flavobacterium breve, Salmonella enterica, enterica serovar Typhimurium, Bacillus atrophaeus spore, Bacillus megaterium, Enterobacter aerogenes, Actinobacillus actinomycetemcomitans, Candida albicans and Ecsherichia coli.

### EXAMPLES

### Example 1

### In-Situ Ozone (O₃) Generation

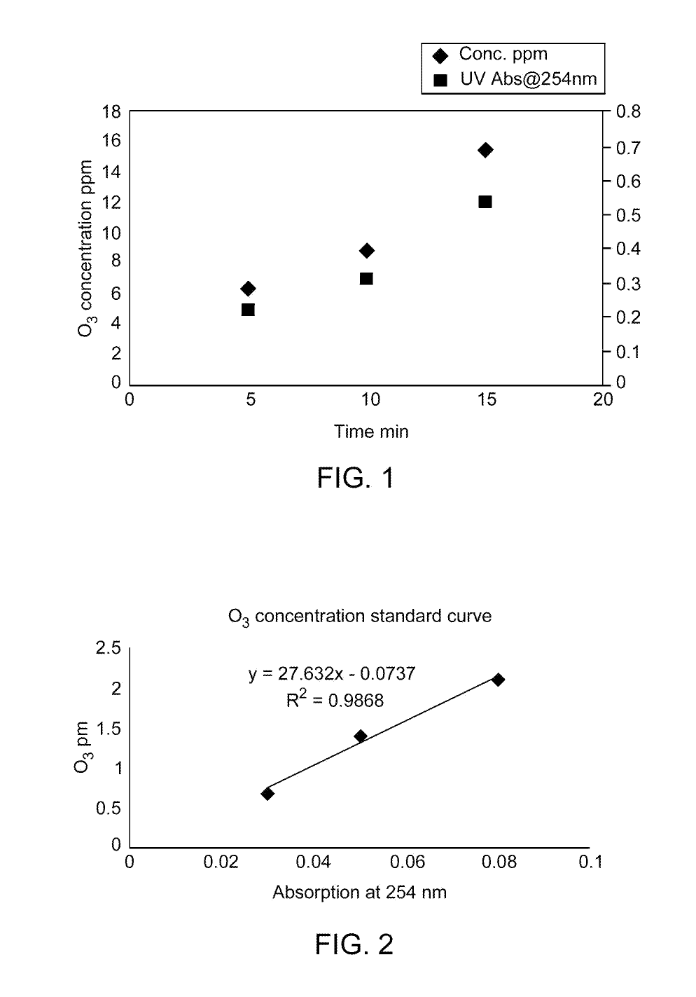

Example 1 demonstrates the generation of ozone (O₃) according to an exemplary embodiment of the invention. The ozone was generated using a single cell with two electrodes without a membrane. The anode was a titanium plate electrode coated with antimony-doped tin oxide. The cathode was a titanium plate electrode coated with ruthenium-iridium Ru/Ir oxide. Each electrode had an area of 4 cm*10 cm. A beaker filled with 1.5 liter of 50 g/l Na₂SO₄ solution served as a recirculation tank. The electrolyte was pumped to the cell at 36 ml/min and the output was discharged back to the beaker. Current at 2 amperes was applied to the cell. As shown in Table 1, the current efficiency ranged from 13% to 19% for this design. FIG. 1 shows the ozone concentration with respect to time and the UV absorption with respect to time. UV absorption is used to characterize the concentration of ozone according to the Lambert-Beer law A=εbc (b=1 cm, ε=310 (mol/L)⁻¹·cm⁻¹), wherein A is the UV absorption, and c is the oxidant (in this case, ozone) concentration. FIG. 2 shows the standard working curve of ozone concentration related to UV absorption.

TABLE 1
Experimental data of single cell for ozone generation

| Current | Time | Voltage | O₃ tested | Abs |
|---|---|---|---|---|
| (A) | (min) | (V) | (ppm) | λ = 254 nm |
| 2 | 5 | 3.73 | 6.34 | 0.223 |
| 2 | 10 | 3.76 | 8.93 | 0.312 |
| 2 | 15 | 3.82 | 15.58 | 0.54 |

### Example 2

### In-Situ Hydrogen Peroxide (H₂O₂) Generation

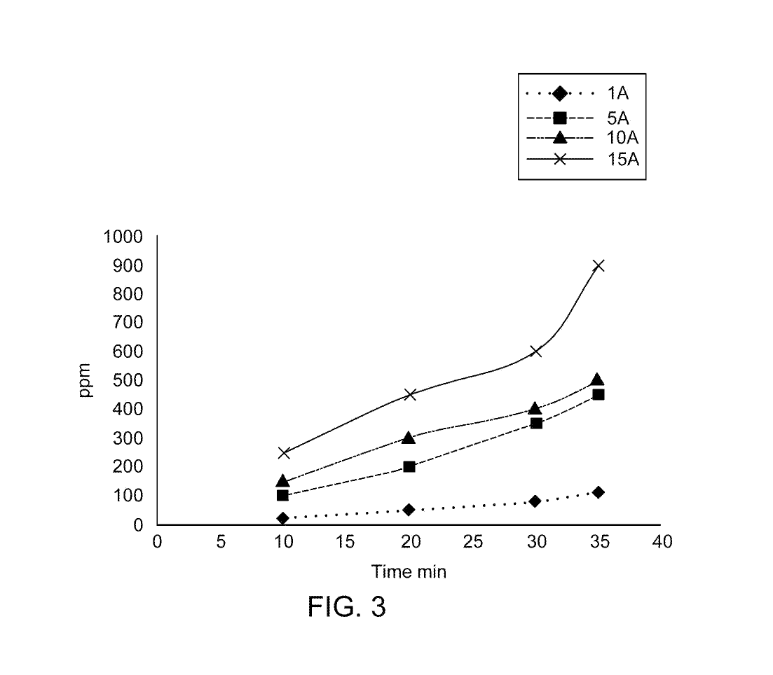

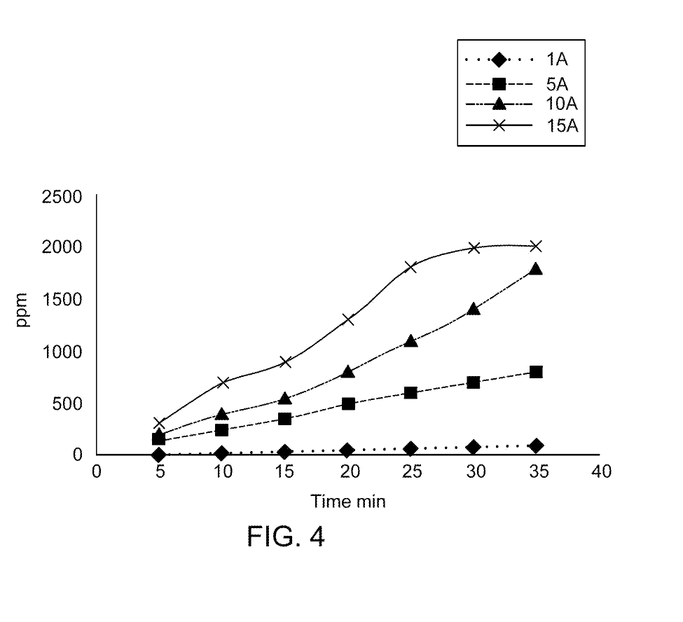

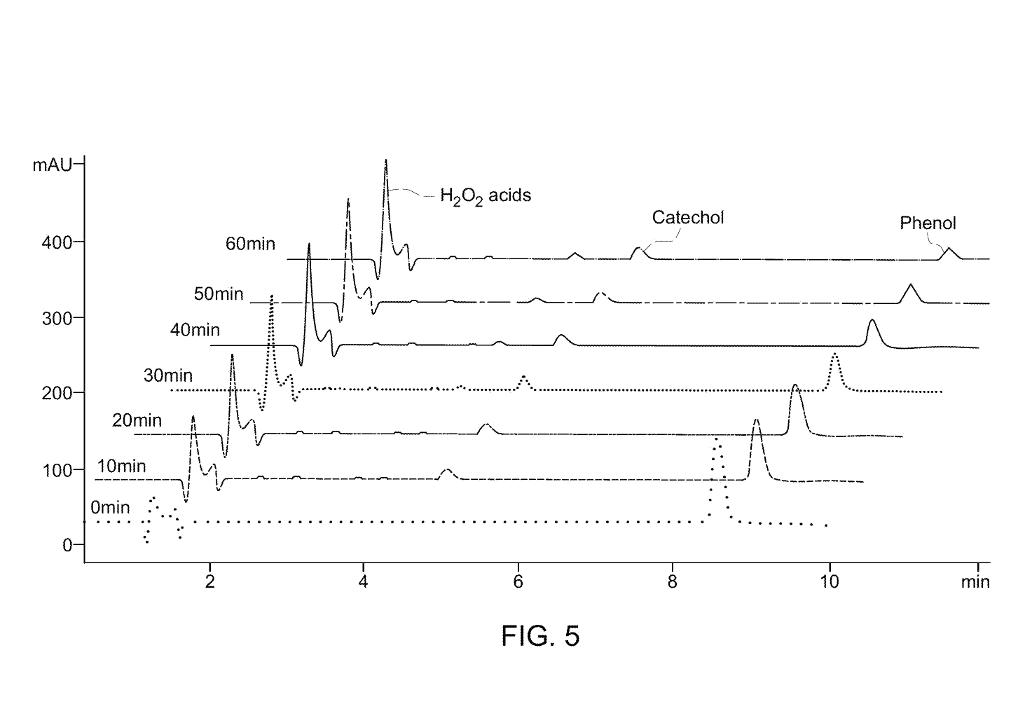

Example 2 demonstrates the generation of hydrogen peroxide (H₂O₂) according to an exemplary embodiment of the invention. The hydrogen peroxide was generated using a tubular single cell with two electrodes without a membrane. The top of the tube is a gas inlet. Two electrodes were at the bottom of the cell. The outside was the anode made from titanium mesh. The inside was the cathode, a gas diffusion electrode. The tubular cell was placed in a beaker with 1.5 liter of 50 g/l Na₂SO₄ solution to serve as a recirculation tank. During operation, the gas traveled from the inside of the cathode out towards the beaker. The gas source was compressed air or oxygen from a pressure swing absorption generator to prevent the gas diffusion electrode from being flooded. Air or oxygen was fed as the catholyte. The electrolyte was pumped to the cell at 36 ml/min and the output was discharged back to the beaker. Current ranging from 1 to 15 amperes was applied to the cell. FIG. 3 shows the hydrogen peroxide generated with respect to time when feeding air to the gas diffusion electrode. FIG. 4 shows the hydrogen peroxide generated with respect to time when feeding oxygen gas to the gas diffusion electrode.

### Example 3

### In-Situ Peroxone (O₃+H₂O₂) Generation

Example 3 demonstrates the generation of peroxone (O₃+H₂O₂) according to an exemplary embodiment of the invention. The peroxone generator was a hollow tube integrated with two tube electrodes configured concentrically. The outside anode was a titanium plate electrode coated with antimony-doped tin oxide. The inside (center) cathode was a gas diffusion electrode. An oxygen-containing gas (pure oxygen, air, etc.) is fed through the inside (center) tube and passes through the gas diffusion electrode and is reduced to hydrogen peroxide. Water was oxidized at the anode to produce ozone. Each electrode had an area of 4 cm*10 cm*4 pieces. A beaker filled with 1.5 liter of 50 g/l Na₂SO₄ solution served as a recirculation tank. The electrolyte was pumped to the cell at 36 ml/min and the output was discharged back to the beaker. Current at 8 and at 15 amperes was applied to the cell. As shown in Table 2, the current efficiency ranged from 2% to 15% for this design.

TABLE 2
Experimental data of single cell for peroxone generation

| Current | Time | Voltage | O₃ | O₃ theoretical | Current |
|---|---|---|---|---|---|
| (A) | (min) | (V) | (ppm) | (ppm) | efficiency |
| 8 | 10 | 2.68 | 40.2 | 265.28 | 15.15% |
| 8 | 20 | 2.66 | 42.8 | 530.57 | 8.07% |
| 8 | 30 | 2.63 | 44.2 | 795.85 | 5.55% |
| 15 | 10 | 3.42 | 62 | 497.41 | 12.46% |
| 15 | 20 | 3.37 | 70.6 | 994.82 | 7.10% |
| 15 | 30 | 3.34 | 30.6 | 1492.23 | 2.05% |

### Example 4

### Treating Neutral pH Water Contaminated with Tough to Treat Organics Using Peroxone (O₃+H₂O₂) Generated In-Situ

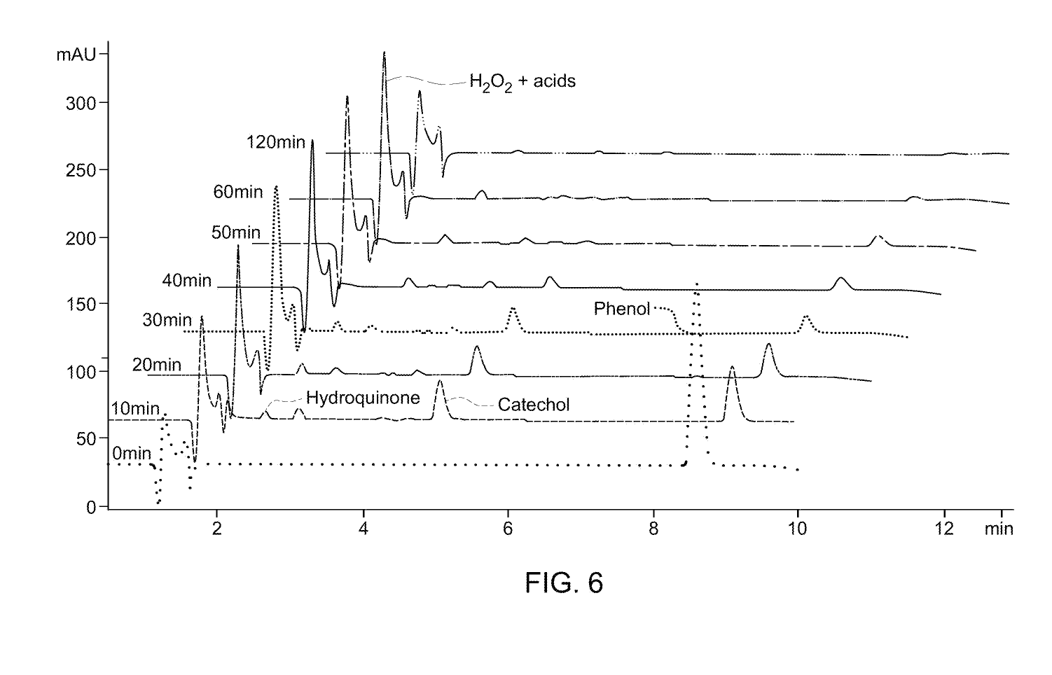

Example 4 demonstrates treating water contaminated with tough to treat organics using peroxone (O₃+H₂O₂) generated in-situ using the peroxone generating apparatus described in Example 3. A beaker was filled with 1.5 liter of prepared water at a neutral pH. The prepared water comprised 50 g/l Na₂SO₄and about 50 ppm phenol. The electrode portion of the peroxone generator described in Example 3 was immersed in the prepared water. The generator was charged with a constant 8 ampere current. Oxygen was fed through the central tube at a constant flow rate of 5 ml/min. A sample was taken out of the prepared water every 10 minutes for 60 minutes. The obtained samples were analyzed for the phenol and catechol (an oxidation byproduct) concentration. After the reaction, the water pH was 4.256. The samples were analyzed using high-performance liquid chromatography (HPLC). Table 3 shows the oxidation results of the prepared water with a neutral pH. FIG. 5 shows the chromatographs of the prepared water samples after treatment.

TABLE 3
Oxidation results of prepared water with neutral pH

| Time | Phenol Conc. | Catechol Conc. |
|---|---|---|
| (min) | (ppm) | (ppm) |
| 0 | 55.4 | 0.0 |
| 10 | 33.6 | 6.3 |
| 20 | 27.9 | 6.9 |
| 30 | 20.6 | 7.3 |
| 40 | 15.4 | 7.2 |
| 50 | 10.4 | 6.8 |
| 60 | 5.9 | 6.4 |

### Example 5

### Treating Alkaline Water Contaminated with Tough to Treat Organics Using Peroxone (O₃+H₂O₂) Generated In-Situ

Example 5 demonstrates treating water contaminated with tough to treat organics using peroxone (O₃+H₂O₂) generated in-situ using the peroxone generating apparatus described in Example 3. A beaker was filled with 1.5 liter of prepared water at an alkaline (10.8) pH. The prepared water comprised 50 g/l Na₂SO₄, about 50 ppm phenol and NaOH to adjust the alkalinity to 10.8 pH. The electrode portion of the peroxone generator described in Example 3 was immersed in the prepared water. The generator was charged with a constant 8 ampere current. Oxygen was fed through the central tube at a constant flow rate of 5 ml/min. A sample was taken out of the prepared water every 10 minutes for 60 minutes. The obtained samples were analyzed for the phenol and catechol (an oxidation byproduct) concentration. After the reaction, the water pH was 10.1. The samples were analyzed using high-performance liquid chromatography (HPLC). Table 4 shows the oxidation results of the prepared alkaline water. FIG. 6 shows the chromatographs of the prepared alkaline water samples after treatment.

TABLE 4
Oxidation results of prepared water with alkaline pH

| Time | Phenol Conc. | Catechol Conc. |
|---|---|---|
| (min) | (ppm) | (ppm) |
| 0 | 55.4 | 0.0 |
| 10 | 16.8 | 10.2 |
| 20 | 10.3 | 8.5 |
| 30 | 5.5 | 7.0 |
| 40 | 3.6 | 5.0 |
| 50 | 2.7 | 3.8 |
| 60 | 1.3 | 0.0 |
| 120 | 0.8 | 0.0 |

### Example 6

### Treating Buffered Water Contaminated with Tough to Treat Organics Using Peroxone (O₃+H₂O₂) Generated In-Situ

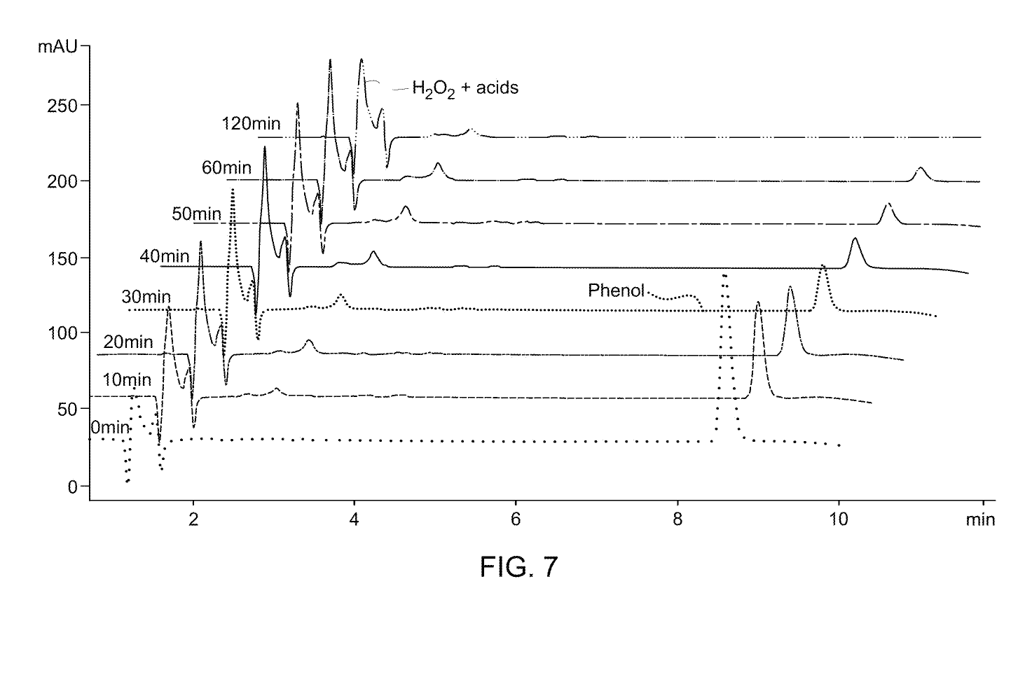

Example 6 demonstrates treating water contaminated with tough to treat organics using peroxone (O₃+H₂O₂) generated in-situ using the peroxone generating apparatus described in Example 3. A beaker was filled with 1.5 liter of prepared water buffered to a pH of 9.6. The prepared water comprised 50 g/l Na₂SO₄, about 50 ppm phenol and enough of a buffered Na₂CO₃NaHCO₃ solution to adjust the alkalinity to 9.6 pH. The electrode portion of the peroxone generator described in Example 3 was immersed in the prepared water. The generator was charged with a constant 8 ampere current. Oxygen was fed through the central tube at a constant flow rate of 5 ml/min. A sample was taken out of the prepared water every 10 minutes for 60 minutes. The obtained samples were analyzed for the phenol and catechol (an oxidation byproduct) concentration. After the reaction, the water pH was 9.733. The samples were analyzed using high-performance liquid chromatography (HPLC). Table 5 shows the oxidation results of the prepared alkaline water. FIG. 7 shows the chromatographs of the prepared alkaline water samples after treatment. As can be seen in FIG. 7, in a buffer controlled condition, the phenol was reduced from 46 ppm to 0.5 ppm and the catechol byproduct was not produced.

TABLE 5
Oxidation results of prepared water with buffered pH

| Time | Phenol Conc. | Catechol Conc. |
|---|---|---|
| (min) | (ppm) | (ppm) |
| 0 | 46.4 | 0.0 |
| 30 | 12.6 | 0.0 |
| 60 | 3.9 | 0.0 |
| 120 | 0.5 | 0.0 |

### Example 7

### In-Situ Chlorine Dioxide (ClO₂) Generation with OBPI-Cotaed Cathode

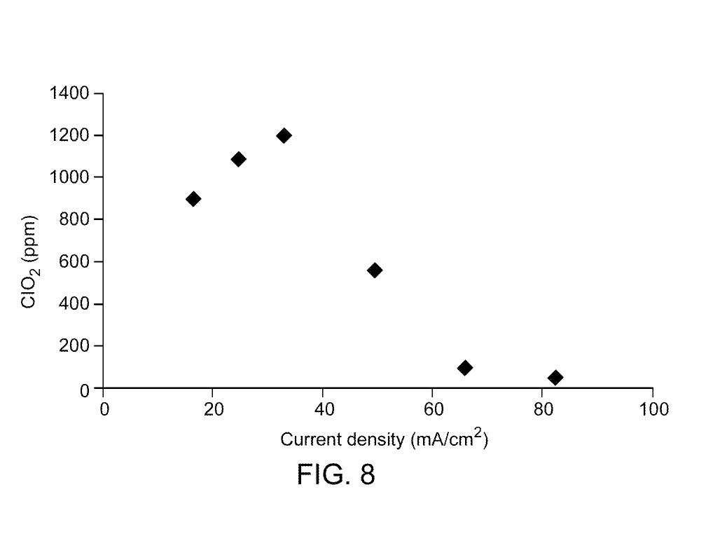

Example 7 demonstrates the generation of chlorine dioxide (ClO₂) according to an exemplary embodiment of the invention. The chlorine dioxide was generated using a single cell with two electrodes. Both the anode and cathode were a titanium plate electrode coated with ruthenium-iridium Ru/Ir oxide. The cathode had a second coating comprising OPBI (poly[2,20-(p-oxydiphenylene)-5,50-bibenzimidazole]) to increase the productivity of the cell by blocking the side reaction that produces chlorate (ClO₃⁻). Each electrode had an area of 4 cm*10 cm. The electrolyte was a 10 g/l NaClO₂ solution. The electrolyte was pumped through the cell one time at 60 ml/min. A current density of 40 mA/cm² amperes was applied to the cell. A counter-current chilled water stream accepted gaseous ClO₂ from production cell after it diffused across the gas permeable membrane. FIG. 8 shows the chlorine dioxide generated using the exemplary system of Example 7.

### Example 8

### In-Situ Chlorine Dioxide (ClO₂) Generation with Uncoated Cathode

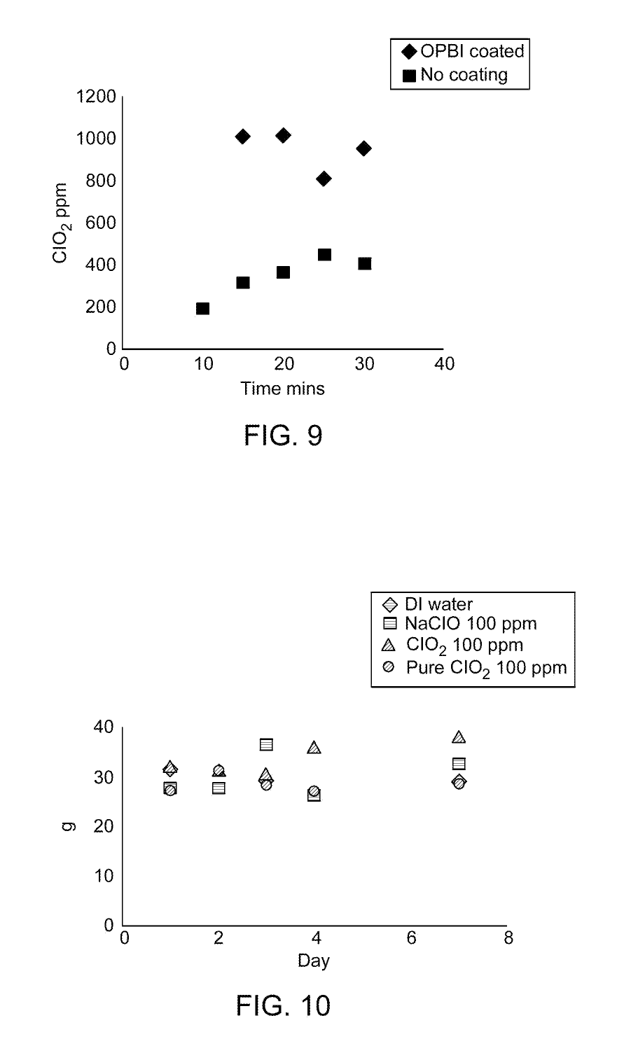

Example 8 demonstrates the generation of chlorine dioxide (ClO₂) according to an exemplary embodiment of the invention. The chlorine dioxide was generated in-situ using the apparatus described in Example 7, except the titanium plate cathode coated with ruthenium-iridium Ru/Ir oxide did not have the second OPBI coating. FIG. 9 shows the chlorine dioxide generation efficiency of both the OBPI-coated cathode and the uncoated cathode systems.

### Example 9

### Reverse Osmosis (RO) Membrane Treatment with Chlorine Dioxide (ClO₂)

Example 9 demonstrates an exemplary embodiment of the invention wherein RO membranes are treated with chlorine dioxide to improve the rejection rate of the membrane. A thin-film reverse osmosis (RO) membrane (AK Series available from General Electric) was immersed in different solutions: DI water; a NaClO solution with free chlorine at 100 ppm; a ClO₂ in-situ generated product solution comprising 100 ppm ClO₂; and a ClO₂ in-situ generated gas product collected in DI water containing 100 ppm ClO₂ (pure ClO₂).

Samples were taken at 1, 2, 3, 4, and 7 days to test the membrane flux and rejection. The flux was characterized by collecting a permeate sample over a period of 10 minutes and measuring the weight of the permeate. The rejection was determined by measuring the conductivity of permeate. The liquid feed was a NaCl solution with a conductivity of 4023 μS/cm. The recirculation water was maintained at 21.7° C. The pressure of the system is 220 MPa.

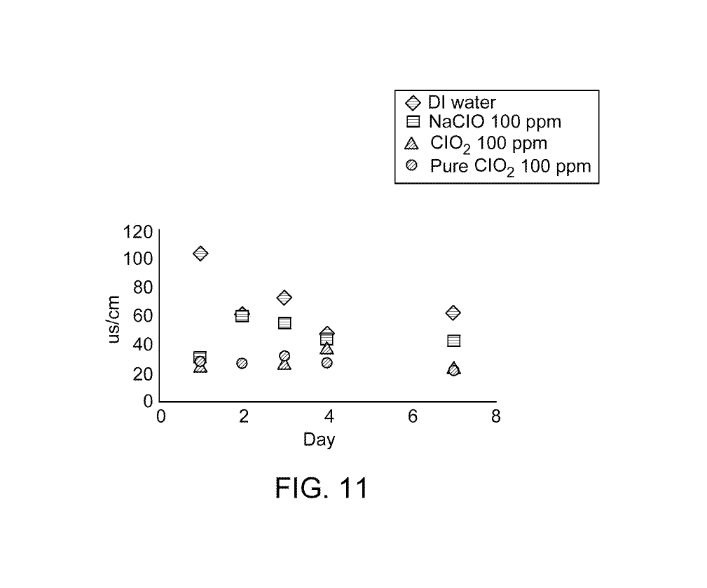

As shown in FIG. 10, the flux did not change much with the different treatment methods. The rejection improved in ClO₂ treated membrane. This indicated that ClO₂may be used to treat RO membranes. ClO₂ may be used to reduce biological contaminants in an aqueous stream and improve the rejection of the RO membrane at the same time. FIG. 11 shows the conductivity of the permeate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of reducing organic compounds in an aqueous stream by generating oxidants in-situ using at least one electrolytic cell, said method comprising contacting at least a portion of said aqueous stream with said electrolytic cell and wherein said electrolytic cell comprises:
a. at least two electrodes, wherein at least one electrode is an anode and at least one electrode is a cathode, and wherein at least one electrode is a metal electrode; and
b. a power source for powering said at least two electrodes.

2. The method of claim 1, wherein said metal electrode comprises a metal selected from the group consisting of titanium, nickel, aluminum, molybdenum, niobium, tin, tungsten, zinc, and combinations thereof.

3. The method as in claim 1, wherein said metal electrode comprises a metal coating selected from the group consisting of ruthenium, iridium, antimony, tin, palladium, platinum, manganese dioxide and combinations thereof.

4. The method as in claim 1, wherein said cathode comprises a polymer coating comprising structural units of formula I 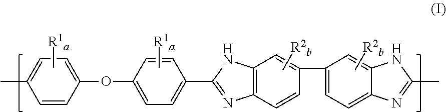
wherein IV is independently at each occurrence a C₁-C₆ alkyl radical or —SO₃M wherein M is independently at each occurrence a hydrogen or an alkali metal, R² is independently at each occurrence a C₁-C₆ alkyl radical, a is independently at each occurrence an integer ranging from 0 to 4, and b is independently at each occurrence an integer ranging from 0 to 3.

5. The method as in claim 1, wherein said electrolytic cell comprises at least two metal electrodes.

6. The method as in claim 1, wherein said electrolytic cell comprises at least one gas diffusion electrode.

7. The method of claim 6, wherein a gas is fed to said gas diffusion electrode and wherein said gas is selected from the group consisting of air, oxygen, and combinations thereof.

8. The method as in claim 1, wherein said electrolytic cell comprises an electrolyte selected from the group consisting of sulfuric acid, sodium sulfate, potassium sulfate, phosphoric acid, sodium phosphate, potassium phosphate, sodium hydroxide, sodium chloride, and combinations thereof.

9. The method as in claim 1, wherein said oxidant is a member selected from the group consisting of ozone, hydrogen peroxide, peroxone, chlorine dioxide, and combinations thereof.

10. The method as in claim 1, wherein said organic compounds comprise an aromatic organic compound.

11. The method as in claim 1, wherein said organic compounds comprise a bacteria selected from the group consisting of Pseudomonas aeruginosa, Pseudomonas fluorescens, Pseudomonas putida, Desulfovibrio desulfuricans, Klebsiella, Comamonas terrigena, Nitrosomonas europaea, Nitrobacter vulgaris, Sphaerotilus natans, Gallionella species, Mycobacterium terrae, Bacillus subtilis, Flavobacterium breve, Salmonella enterica, enterica serovar Typhimurium, Bacillus atrophaeus spore, Bacillus megaterium, Enterobacter aerogenes, Actinobacillus actinomycetemcomitans, Candida albicans and Ecsherichia coli.

12. The method as in claim 1, wherein said organic compounds comprise N-containing organics or organic acids.

13. A water treatment system for generating an oxidant in-situ comprising at least one electrolytic cell, wherein said electrolytic cell comprises:
a. at least two electrodes, wherein at least one electrode is an anode and at least one electrode is a cathode, and wherein at least one electrode is a metal electrode; and
b. a power source for powering said at least two electrodes.

14. The system of claim 13, wherein said metal electrode comprises a metal selected from the group consisting of titanium, nickel, aluminum, molybdenum, niobium, tin, tungsten, zinc, and combinations thereof.

15. The system as in claim 13, wherein said metal electrode comprises a metal coating selected from the group consisting of ruthenium, iridium, antimony, tin, palladium, platinum, manganese dioxide and combinations thereof.

16. The system as in claim 13, wherein said cathode comprises a polymer coating comprising structural units of formula I 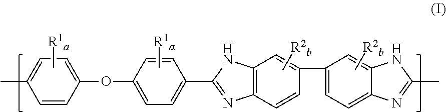
wherein R¹ is independently at each occurrence a C₁-C₆ alkyl radical or —SO₃M wherein M is independently at each occurrence a hydrogen or an alkali metal, R² is independently at each occurrence a C₁-C₆ alkyl radical, a is independently at each occurrence an integer ranging from 0 to 4, and b is independently at each occurrence an integer ranging from 0 to 3.

17. The system as in claim 13, wherein said electrolytic cell comprises at least two metal electrodes.

18. The system as in claim 13, wherein said electrolytic cell comprises at least one gas diffusion electrode.

19. The system of claim 18, wherein a gas is fed to said gas diffusion electrode and wherein said gas is selected from the group consisting of air, oxygen, and combinations thereof.

20. The system as in claim 13, wherein said electrolytic cell comprises an electrolyte selected from the group consisting of sulfuric acid, sodium sulfate, potassium sulfate, phosphoric acid, sodium phosphate, potassium phosphate, sodium hydroxide, sodium chloride, and combinations thereof.

21. The system as in claim 13, wherein said oxidant is a member selected from the group consisting of ozone, hydrogen peroxide, peroxone, chlorine dioxide, and combinations thereof.

22. A method of improving the rejection rate of a reverse osmosis membrane using an oxidant generated in-situ, said method comprising:
a. contacting at least a portion of said aqueous stream with said electrolytic cell thereby creating an oxidized aqueous stream; and
b. feeding at least a portion of said oxidized aqueous stream through a reverse osmosis membrane;
c. wherein said electrolytic cell comprises:
i. at least two electrodes, wherein at least one electrode is an anode and at least one electrode is a cathode, and wherein at least one electrode is a metal electrode; and
ii. a power source for powering said at least two electrodes.

23. The method of claim 22, wherein said metal electrode comprises a metal selected from the group consisting of titanium, nickel, aluminum, molybdenum, niobium, tin, tungsten, zinc, and combinations thereof.

24. The method as in claim 22, wherein said metal electrode comprises a metal coating selected from the group consisting of ruthenium, iridium, antimony, tin, palladium, platinum, manganese dioxide and combinations thereof.

25. The method as in claim 22, wherein said cathode comprises a polymer coating comprising structural units of formula I 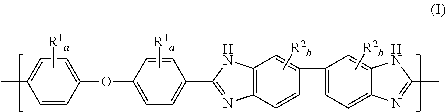
wherein R¹ is independently at each occurrence a C₁-C₆ alkyl radical or —SO₃M wherein M is independently at each occurrence a hydrogen or an alkali metal, R² is independently at each occurrence a C₁-C₆ alkyl radical, a is independently at each occurrence an integer ranging from 0 to 4, and b is independently at each occurrence an integer ranging from 0 to 3.

26. The method as in claim 22, wherein said electrolytic cell comprises at least two metal electrodes.

27. The method as in claim 22, wherein said oxidant comprises chlorine dioxide.

28. The method as in claim 22, said method further comprising reducing organic compounds in said aqueous stream, wherein said organic compounds comprise a bacteria selected from the group consisting of Pseudomonas aeruginosa, Pseudomonas fluorescens, Pseudomonas putida, Desulfovibrio desulfuricans, Klebsiella, Comamonas terrigena, Nitrosomonas europaea, Nitrobacter vulgaris, Sphaerotilus natans, Gallionella species, Mycobacterium terrae, Bacillus subtilis, Flavobacterium breve, Salmonella enterica, enterica serovar Typhimurium, Bacillus atrophaeus spore, Bacillus megaterium, Enterobacter aerogenes, Actinobacillus actinomycetemcomitans, Candida albicans and Ecsherichia coli.
